(19) United States
(12) Patent Application Publication
(10) Pub. No.: US 2026/0200593 A1
(43) Pub. Date: Jul. 16, 2026

(54) LANDING PAD FOR AERIAL VEHICLE WITH GRANULE-BASED LOCKING MECHANISM

(71) Applicant: DRONE LANDER LTD., Savyon (IL)

(72) Inventors: Jonathan BENZION CARNI, Savyon (IL); Shlomo MAGDASSI, Jerusalem (IL); Michael KARP, Rosh HaAyin (IL); Mordechay ALBO, Kibbutz HaMa'apil (IL); Elad MORDEHAY, Tel Aviv (IL)

(21) Appl. No.: 19/556,336

(22) Filed: Mar. 4, 2026

Related U.S. Application Data
(63) Continuation of application No. PCT/IL2025/050074, filed on Jan. 21, 2025.
(60) Provisional application No. 63/634,682, filed on Apr. 16, 2024.
(60) Provisional application No. 63/555,531, filed on Feb. 20, 2024.
(60) Provisional application No. 63/555,523, filed on Feb. 20, 2024.

(51) Int. Cl. B64F 1/02; B64F 1/12; C08J 9/00

(52) U.S. Cl. CPC B64F 1/02; B64F 1/12; C08J 9/0009

(57) ABSTRACT

A landing pad for a vertically landing aerial vehicle includes granules or other particulate material arranged in a container. The granules or other particulate material are dispersed, thereby permitting embedding of legs of the aerial vehicle within the granules or other particulate material and withdrawal of the legs from within the granules or other particulate material.

### RELATED APPLICATIONS

The present application is a continuation of International Patent Application No. PCT/IL2025/050074, filed January 21, 2025, which claims priority to U.S. Provisional Patent Application 63/555,523, filed February 20, 2024, entitled “Landing Pad for Landing Unmanned Aerial Vehicle on Moving Surface,” U.S. Provisional Patent Application No. 63/555,531, filed February 20, 2024, entitled “Magnetic Locking and Releasing Mechanism for Securing Unmanned Aerial Vehicle on Landing Pad,” and U.S. Provisional Patent Application No. 63/634,682, filed April 16, 2024, entitled “Drone Landing Pad with Granule-Based Locking Mechanism,” the contents of each of which are hereby incorporated by reference as if fully set forth herein.

### TECHNOLOGICAL FIELD

The present disclosure relates to the field of unmanned aerial vehicles, and more specifically, but not exclusively, to a particle-based catching, locking and releasing mechanism for securing an unmanned aerial vehicle on a landing pad mounted on a moving vehicle.

### BACKGROUND

Many aerial Vehicles (AV), including unmanned aerial vehicles also known as drones, require a vertical, or nearly vertical, landing. In a best-case scenario, the vehicles land on a stationary landing pad at an airport, heliport, or other locations, clear of obstacles. The landing process begins with an approach to the landing pad. After reducing flight speed, the aerial vehicle continues to a vertical, or nearly vertical, final approach relative to the landing pad, and at a low height a touchdown process is performed.

Environmental conditions affect the ability of a vertically landing aerial vehicle to land safely. Such environmental conditions may include high wind, turbulence, rain, and waves in a marine environment. In particular, a vertically landing aerial vehicle starts its touchdown process by reducing its power for descending, causing it to become vulnerable to winds that can cause it to be swept, turn over and crash during or after touchdown. In addition, a wet landing pad could cause the vertically landing aerial vehicle, following touchdown, to slip off the landing pad and crash. The high crash risk effectively prevents operation of the vertically landing aerial vehicle in harsh conditions. For landing pads mounted on moving vehicles (car, track, train, boat, ship etc.) the environmental conditions include motion of the landing pad in different directions and angles, vibrations, and shaking, which generate up to 6 relative degrees of motion between the drone and the landing pad, all increasing the likelihood of a crash or turn-over.

Locking down of the aerial vehicle onto the landing pad is also necessary during the landing process, especially in challenging environmental conditions. Aerial vehicle touchdown at a high descent rate may cause the aerial vehicle to bounce back into the air, becoming exposed to winds and turbulence with no control of the AV. Once the aerial vehicle has safely landed, it is also desirable to maintain the aerial vehicle in a parked position by locking its legs, so that it will not slide off the landing pad when the landing pad sways or bucks.

Most described solutions for fixation of the legs of the landing aerial vehicle upon touchdown are based on mechanical means, such as clamps or brackets, or magnetic/electromagnetic means. Herein, “legs” means any part of the landing aerial vehicle which comes into contact with the landing pad. The structure of the legs (also referred to as skids) may be, but not limited to, structures such as vertical or horizontal rods or cylinders, circular shaped rod, a circular or rectangular wire etc., at various dimensions. The leg can be smooth or have a surface structure and can be composed but not limited to materials such as polymer and metals.

Prior art devices utilize flat and hard landing pad surfaces, which complicate the smooth and soft AV landing and the securing of the AV under conditions of winds and waves, such as that encountered at sea. In addition, existing solutions for securing of AVs on landing pads feature various limitations. These include: the necessity of precise alignment between the AV and the pad, and the need for specialized equipment on the landing gear of the AV.

One technical solution for securing objects, in general, involves the use of vacuum-packed particles or granules. In such solutions, a bag containing small particles or granules is arranged at least partially around an object. A vacuum is then applied to the bag. Due to the evacuation of air and the frictional forces between the granules, the bag is converted from a flexible state to a solid state, thereby securing the object. Vacuum packed particles have typically been used, inter alia, for robotic gripping and for application of casts and splints.

Memory foam is a viscoelastic polymeric material that typically retains its shape after a depression is applied thereto, at least for a limited period of time.

### REFERENCES

Robotic catching or securing mechanisms, including mechanisms utilizing vacuum packed particles or granules, are generally disclosed in US2015/014970, WO2015123128A1, US11872691B2, US11897099B2, US2017/0360589A1, US20230286177A1, US11865702B2, US2005/0137513, EP4161743B1, WO2024/228657A1, and US20240001565A1.

Mechanical means for leg fixation of UAVs are described in KR102069241B1, CN108860639A, and KR101982398B1. Magnetic/electromagnetic means are described in KR101960174B1, KR102038678B1, CN107168318A, KR101617594B1, CN204822098U, CN113602518A, CN110155265A, KR20180043108A, US20230100169A1, US9505493B2, US11459100B2, US20210122495A1,. US20230045691A1, US08051791B2, and US11655049B1. Hook and eyelet (Velcro®) type means are described in KR20150057619A.

### SUMMARY OF THE INVENTION

The present disclosure addresses a “catch, lock and release” landing pad system for a AV with a securing mechanism incorporating vacuum packed particles. The disclosed system enables safe vertical landing, parking, and take-off of the AV in harsh environmental conditions. The system described herein may be applied for the landing of any AV, regardless of whether it contains specialized landing gear. Furthermore, the AV may be secured on the landing pad so long as it touches down substantially parallel to the landing pad, and regardless of the specific orientation of the AV on the yaw axis relative to the landing pad.

In some embodiments, the pad comprises granules enclosed within an open box or in a pouch or in a pillow-like structure above the landing pad base. The drone lands on the granules, its legs (or lower part of them) are embedded (penetrated) within the granules. The cushioning by the cushion enables the touch-down, and upon contact with the landing skids, prevents the aerial vehicle from bouncing back, as well as eliminates (or decreases) slippage on the pad surface.

In particular, the landing pad is equipped with a vacuum-based catching mechanism. When the granules are encapsulated within an airtight pillow, upon contact of the skids, the air is sucked out of the pillow, which causes hardening (solidifying) of the whole volume occupied by the granules, and thus strongly securing the legs, to keep the drone or aerial vehicle (AV) locked down safely even during severe weather conditions. Allowing the air flow into the pillow restores the softness of the pillow and enables the AV to securely take off.

Below are the detailed embodiments and conditions supporting this invention.

As used in the present disclosure, the term “unmanned aerial vehicle” (UAV), or “aerial vehicle” (AV) or “drone” refers to a vertically landing aerial vehicle. The aerial vehicle “skids” for landing are named also as “landing gear” or “legs”.

The term “landing pad” (LP) refers to the surface on which the aerial vehicle lands. The landing pad may be part of a larger landing pad apparatus with additional parts. These additional parts may include a “pad base,” which is a flat, rigid surface on which the landing pad may be arranged; and a horizontal stabilizing support, which is used to control the position and angular orientation of the landing pad and landing pad base.

The term “granules” refers to particles in various size ranges, also denoted here as grains.

The term “vacuum source” refers to a device for reducing the air pressure in a closed pillow, such as a vacuum pump, low pressure air tank, etc.

The term “air source” refers to a device for introducing air flow into a closed volume, such as a compressor, air-pump, blower, or high-pressure gas tank.

The term “pillow-like” describes certain physical characteristics of a container. These physical characteristics include: softness, cushioning, and the presence of excess air that may be pumped in or withdrawn.

Additional terms will be explained further herein.

According to a first aspect, a landing pad for a vertically landing aerial vehicle is disclosed. The landing pad includes granules or other particulate material arranged in a container. The granules or other particulate material are dispersed, thereby permitting embedding of legs of the AV within the granules or other particulate material and withdrawal of the legs from within the granules or other particulate material.

The granules or other particulate material may have a total height of between 5 and 300 mm. size of each granule or particle is between 0.1 and 10 mm.

The granules or particulate material may be comprised of one or more of metal beads, plastic beads, ceramic beads, plastic pellets, coarse sand, couscous, buckwheat, bulgur, quinoa grains, or powders. The granules or particulate matter may also comprise pieces or layers of material comprising one or more of foam, fabrics, felt, rubber, leather, or wool or cotton fibers. The material for the granules may be selected based on various characteristics, including durability, coefficient of friction, availability, and cost. In one advantageous embodiment, the granules are made of plastic pellets having a size of between 1 and 5mm. Such plastic pellets are durable, do not biodegrade (and thus are environmentally stable), and are readily commercially available.

The container of the landing pad may be arranged on a planar pad base. The pad base is a platform which supports the container. For the avoidance of doubt, the landing pad may exist as a standalone product, regardless of the type of base on which it is mounted. The landing pad may also be implemented as a removable and replaceable cartridge, which may be prepared separately from the pad base and installed thereon.

In some embodiments, the container is an open-air container. In such embodiments, the landing gear of the aerial vehicle becomes embedded directly between the granules or particulate matter.

In alternative embodiments, the container is a flexible, sealed container, with the granules inside. The landing gear thus lands on top of the container, and depresses the top of the container, thereby becoming embedded within the granules or particulate matter.

Optionally, a foam rubber layer is configured between the container and the pad base. The foam rubber layer is used to provide further cushioning and impact resistance for the aerial vehicle as it lands on the landing pad. The foam rubber may be made of any suitable material, including polyurethane.

A layer of air may be configured above the granules. This layer of air may be expandable or removable through the pumping of additional air into the container or removal of air from the container. An air pump may be configured to fill the container with air. A vacuum source may be implemented to withdraw air from the container. In the absence of a vacuum, the granules or other particulate material are dispersed, thereby permitting embedding of legs of the aerial vehicle within the granules or other particulate material and withdrawal of the legs from within the granules or other particulate material, and, in the presence of a vacuum, the granules or other particulate material are compacted, thereby locking the granules or other particulate material around the legs when the legs are embedded within the granules or other particulate material.

A sensor may be implemented for determining when legs of the aerial vehicle are embedded within the granules or other particulate material. A controller may be configured to activate the vacuum source upon determination that the legs are exerting pressure on the granules or other particulate material. The sensor may be a load cell which has one or more strain gauges. The load cell may be configured underneath the container. Advantageously, in such embodiments, the vacuum engages to lock the landing gear in an automated process as soon as the landing gear touches down on the landing pad, thereby protecting the aerial vehicle and preventing it from slipping off the landing pad.

The vacuum source may be configured to exert a vacuum of between 10 to 800 mbar, and more preferably between 80 to 500 mbar.

The vacuum source may include a piston connected to a storage tank. The storage tank is configured for storage of air withdrawn from the container during application of vacuum and for resupply of air to the container during release of the vacuum.

The container may be made of a soft, flexible material and thereby constitute a pillow-like receptacle. The pillow-like receptacle may be waterproof and airtight. The container of the pillow-like receptacle may be made of plastic film, rubber, fabrics, or any combination thereof. The pillow-like receptacle may include excess soft, flexible pillow-like material configured above the granules or other particulate material. Upon landing of the legs of the aerial vehicle onto the landing pad, the legs depress a portion of the excess soft, flexible material prior to becoming embedded within the granules or other particulate material. In this case, the legs penetrate into the granules together with the excess of pillow material, reducing the effect of moving granules away from the legs, thereby causing tougher enfolding of the skids with granules and therefore stronger locking.

An air pump may be configured within the landing pad so that it may partially fill the soft, flexible material with air prior to landing of the aerial vehicle on the landing pad, or prior to release of the aerial vehicle on the landing pad. Advantageously, in the case of landing, the partially air-filled pillow-like material may be used to absorb the initial impact of landing prior to engaging of the locking mechanism. In the case of release, the providing of air in the material assists releasing of the vacuum and softening of the pillow with the granules, enabling safe unlocking of the legs.

In situations in which there is an excess of air within the pillow-like receptacle, various components may be added or included to enable the receptacle to preserve structural integrity. Optionally, rubber columns are configured within the pillow-like receptacle. In a relaxed state, the rubber columns elevate the surface of the pillow-like receptacle. The rubber columns are bent upon landing of the aerial vehicle on the surface of the pillow-like receptacle.

The landing pad may also include one or more air bags with a plurality of hollow pillars arranged underneath the pillow-like receptacle, and a pump configured to pump air into the one or more air bags to inflate the pillars and thereby elevate the granules or other particulate matter within the pillow-like receptacle. This helps ensure that the granules or particulate matter are able to surround the landing gear after it has touched down on the pillow-like material.

A landing pad assembly may include a plurality of the landing pads arranged on a common pad base. Each of the landing pads may be made of a flexible, sealed, pillow-like container with the granules inside. There may be separators arranged between the landing pads. For example, the landing pads and separators may be arranged as parallel strips. When the aerial vehicle is properly guided to the landing pad assembly, the landing gear touches down on a portion of the assembly having the landing pads. Thus, the landing pads having the granules are confined to locations on which the landing gear is expected to land. The separators may be made of memory foam. Advantageously, even if the aerial vehicle leg or a part of it is landed on the separators instead of the landing pads, the memory foam absorbs the shock of the landing without causing bounce-back of the landing gear.

In a second implementation, a landing pad for a vertically landing vehicle is disclosed. The landing pad includes a landing surface made of memory foam. The memory foam may be enclosed in an airtight container made of a soft, flexible material. The container may be filled with a layer of air.

In a third implementation, an apparatus legs of an aerial vehicle. The legs are shaped specifically to enable penetration into the granules or other particulate material of the landing pad and to allow the legs to be enfolded into the pillow with granules and secured by the landing pad upon application of the vacuum. The legs may include a lower portion having a relatively thinner cross section and an upper portion comprising a securing component in a relatively thicker cross section. When the aerial vehicle descends onto the landing pad, in a first stage, the lower portions of the legs are embedded within the granules or other particulate material to thereby form channels. In a second stage, the securing components contact an upper surface of the landing pad, thereby sealing the channels from above. The legs may be manufactured with at least one of a shape, a size, a material, or a surface roughness that promotes adhesion of the legs to an upper surface of the landing pad.

In a fourth implementation, a system for landing a vertically landing aerial vehicle comprises the landing pad as disclosed, wherein the upper surface of the landing pad functions as a touchdown surface, and the landing pad is arranged on a vehicle. At least one inertial measurement unit is configured to measure speed, acceleration, and angular orientation of the base. A controller is configured to: receive measurements from the at least one inertial measurement unit; receive data regarding speed, acceleration, and angular orientation of the aerial vehicle; calculate and predict a future location and orientation of the landing pad based on expected future movement of the vehicle; and provide instructions to the aerial vehicle regarding the flight path required so that the aerial vehicle will land on the landing pad with minimal relative position and velocity error. The system may further include an electromechanical structure configured to stabilize the touchdown surface during movement of the vehicle, wherein the controller is configured to control the electromechanical structure so as to maintain the touchdown surface substantially horizontal relative to ground or sea level while the aerial vehicle is landing. The electromechanical structure may include a plurality of extendable and retractable legs.

In a fifth implementation, a method of landing a vertically landing aerial vehicle is disclosed. The method includes: lowering legs of the aerial vehicle onto a landing pad comprising a plurality of granules or other particulate material arranged in a container, wherein the landing pad further comprises a vacuum pump configured to withdraw air from the container; embedding the legs of the aerial vehicle within the granules or other particulate material; and applying a vacuum to the container to thereby compact the granules or other particulate material and lock the granules or other particulate material around the legs causing locking of vehicle to the landing pad. Releasing of the vacuum leads to unlocking of the vehicle. The container may be a sealed, flexible container with the granules inside, and the landing pad may further include an air pump. In such configurations, the method further comprises, prior to the lowering step, pumping air into the container. The method may further include withdrawing air from the container until the container reaches a default minimum internal pressure, and wherein the step of pumping air into the container comprises raising an internal pressure in the container to a predetermined level. Advantageously, in such embodiments, the internal pressure of air within the container is always the same when the aerial vehicle is landing.

The amount of vacuum that is applied may be calculated according to the particular needs of the landing and locking process. For example, the vacuum may be calculated based on the force required for adequate insertion of the legs into the granules or other particulate material, based on the mass and configuration of the legs. The vacuum may be applied at a degree suitable to generate such force.

The method may further include lowering the aerial vehicle to a distance of 10-1000 mm from the surface of the pad using a motor of the aerial vehicle, and lowering the aerial vehicle a remaining distance to the landing pad using gravity.

The lowering step may also comprise calculating a required force needed for an adequate insertion into the granules or other particulate material according to the mass and configuration of the legs of the aerial vehicle, and applying suitable vacuum in order to generate such force.

The method may additionally include, during performance of the other steps, horizontally stabilizing the landing pad with an electromechanical structure equipped with sensors to measure motion of a vehicle on which the landing pad is arranged.

In a sixth implementation, a method of landing a vertically landing aerial vehicle on a landing system of a moving vehicle is disclosed. The landing system comprises at least one inertial measurement unit configured to measure speed, acceleration, and angular orientation of the base; and a controller, and the method comprises: receiving measurements from the at least one inertial measurement unit; receiving data regarding speed, acceleration, and angular orientation of the aerial vehicle; calculating and predict a future location of the landing pad based on expected future movement of the vehicle; and providing instructions to the aerial vehicle regarding the flight path required so that the aerial vehicle will land on the landing pad.

Optionally, the controller commands the aerial vehicle when and where to touch down.

### BRIEF DESCRIPTION OF THE DRAWINGS

To better understand the subject matter that is disclosed herein and to exemplify how it may be carried out in practice, embodiments will now be described, by way of non-limiting example only, with reference to the accompanying drawings, in which:

FIGS. 1A-1B illustrate a schematic view of a drone landing on a landing pad with granules in a box.

FIGS. 2A-2D illustrate a schematic view of a drone landing on a landing pad with granules in a pillow-like container. FIG. 2C has an additional vacuum system and a sensor for determining that the landing has occurred. FIG. 2D illustrates an embodiment where the sensor includes one or a few load cells installed under the pad base.

FIGS. 3A-3C illustrate a schematic view of a drone landing on a landing pad with granules in the pillow in which only part of the pillow is filled with granules and it has an excess of soft, flexible pillow material.

FIGS. 4A-4C show spreading of excess of pillow material above the surface by blowing air into the pillow prior to drone touchdown.

FIGS. 5A-5B show spreading of excess of pillow material above the surface by using flexible rubber columns.

FIGS. 6A-6B illustrate a schematic view of the landing pad with addition of a foam rubber layer between the pillow and the base.

FIG. 7 shows examples of patterned foam.

FIGS. 8A-8B illustrate a schematic view of a matrix of fillable air bags (balloons, or pillars etc.) configured under the pillow.

FIGS. 9A-9B illustrate a schematic view of a pad with a pillow shaped like a matrix of pillars.

FIG. 10A illustrates a landing pad system including multiple pads arranged on a common pad base and sharing a common air pump system.

FIG. 10B illustrates a landing pad system including multiple pads arranged on a common pad base, sharing a common air pump system, and with separators made of memory foam.

FIG. 10C is a top view of the landing pad of FIG. 10A;

FIGS. 10D-10F are top views of exemplary landing pad systems according to FIG. 10B;

FIGS. 11A-11D illustrate a schematic view of a design of drone legs for stronger securing after the landing;

FIG. 12 is another example of a design of drone legs for better securing after landing;

FIG. 13 is a further example of a design of drone legs for better securing after landing.

FIG. 14 is a further example of a design of drone legs.

FIG. 15 is a landing pad installed on an electro-mechanical stabilized mechanism mounted on a boat; and

FIG. 16 illustrates a prediction function for a safe touchdown of the aerial vehicle on the landing pad.

### DETAILED DESCRIPTION OF EMBODIMENTS

The present disclosure relates to the field of aerial vehicles, and more specifically, but not exclusively, to a landing pad for landing safely a vertically landing aerial vehicle, including in harsh conditions caused by environmental conditions, for any pad location such as for example but not limited to, on a movable vehicle, such as on the deck of a ship, or a train roof etc.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

As used in the present disclosure, the term “aerial vehicle” specifically includes an unmanned aerial vehicle, also known as a “drone,” although the landing pad of the present disclosure may also be used for the landing of manned aerial vehicles.

As used in the present disclosure, the term “vessel” or “movable vehicle” refers to a moving vehicle whose landing pad is moving in a single or multiple directions and angles relative to earth. One example used in the present disclosure is a ship; however, land-based vehicles, such as trucks, are likewise included.

The landing pad system described herein enables aerial vehicles to land and take off in harsh conditions. The harsh conditions could be caused, for example, by stormy weather, winds, or high seas. The main concern in operation of the aerial vehicles in such conditions is that during touchdown and / or power shutdown phase, wind or motion of the landing pad may cause the aerial vehicle to crash. The solution described herein enables the aerial vehicle to land and prevents the aerial vehicle from falling off the landing pad.

Landing an aerial vehicle on a maritime vessel in harsh conditions is especially complex and dangerous, since the high sea waves cause the landing pad, together with the vessel, to move in all directions, and the wave splashes cause the pad to be wet and slippery. Accordingly, the present disclosure provides a system that enables safe landing on vessels at high sea conditions. The system enables landing of aerial vehicles on land vehicles when they are being driven on any type of road condition, or on high buildings, or any other location with severe conditions.

The system described herein is self-contained and suitable for any aerial vehicle size or type. The system is made of materials that can withstand an outdoor maritime environment. The system is scalable to any dimension, and thus may be applied for aerial vehicles having landing gear of any size.

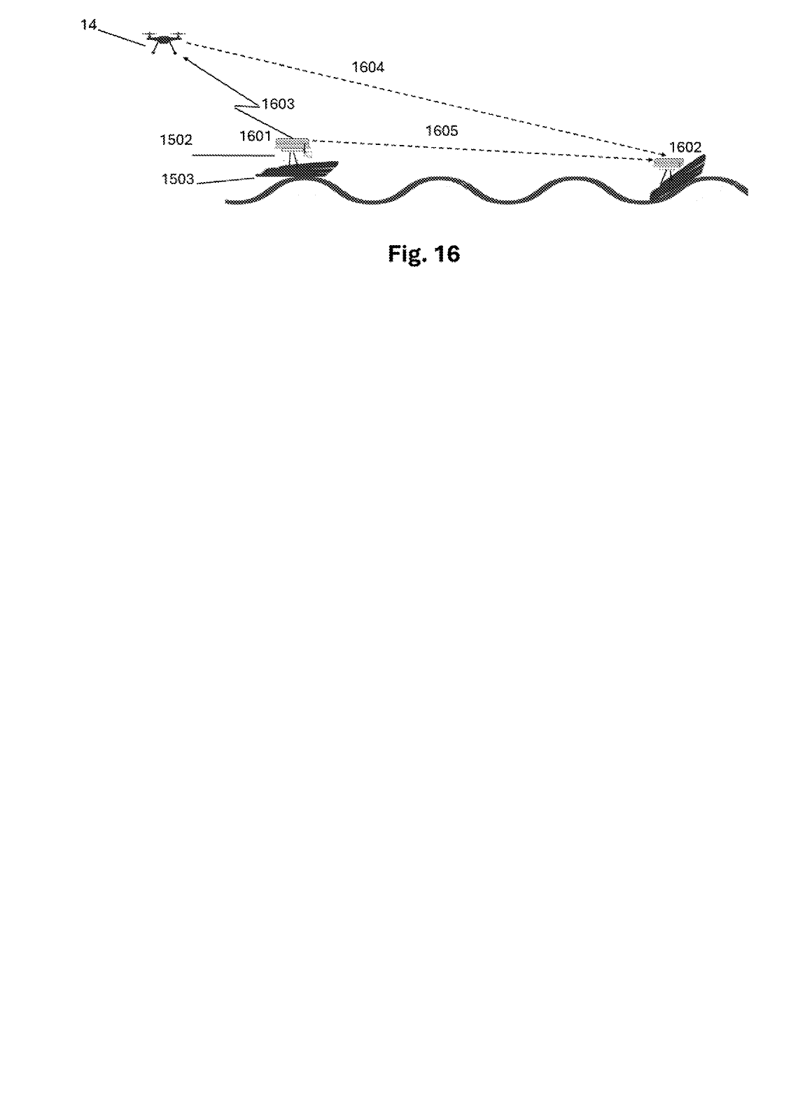

The systems and methods described herein may be integrated with other systems for orienting aerial vehicles during a landing process. For example, the landing pad may be perched on a stabilizing platform, which may have motion in up to six degrees of freedom. In addition, an onboard computer and sensors may be configured on the landing pad or on the aerial vehicle. The onboard computer is configured to receive sensor data regarding the speed and orientation of the aerial vehicle relative to the landing pad. The computer predicts the future location of the landing pad and provides the flight instruction to the aerial vehicle to land on the landing pad. Some examples of such mechanisms are discussed below in connection with FIGS. 15 and 16. In another example, the landing pad may be equipped with various visual markers that may be detected by the sensors of the aerial vehicle. Regardless of the specific mechanisms that are employed, it is presumed that it is possible to align the aerial vehicle with the landing pad during a landing process. A subsequent challenge then arises of ensuring that, once the aerial vehicle is properly aligned with the landing pad and touches down, the aerial vehicle is properly secured on the landing pad. This challenge is especially pertinent when the landing pad is oscillating on a rocking boat.

For a landing pad mounted on a ship or any other moving vehicle, a computer connected to sensors measures the motion of the ship, calculates and predicts the future location of the landing pad. The landing pad’s location is affected by the waves and ship’s behavior. The computer provides instructions to the aerial vehicle regarding the flight path and guides it to the future touchdown point on the landing pad. This enables the aerial vehicle to follow a smooth final approach with minimal maneuvering and maximum safety.

The landing pad may comprise a layer of granules or other particulate material. The term “granule” is used to refer to a material in a substantially spherical shape, while the term “other particulate material” encompasses materials in other shapes. In general, for the remainder of this disclosure, the term “granules” is used to refer to other particulate material as well, unless the context dictates otherwise. The thickness of this layer may be in the range of 5 to 300 mm, preferably 10 – 50 mm, with the individual granules having a size of 0.1 to 10 mm, preferably 1-5 mm. The term “size” is understood to mean a diameter, in the case of a spherical granule, or maximum length from one side to the other, in the case of a non-spherical granule. The granules act at first as a cushion to absorb the descending aerial vehicle’s momentum, and to avoid a bounce-back effect and/or slipping off the pad. Following application of a vacuum, the granules harden over the landing gear, thereby locking the landing gear in place.

The figures below schematically describe embodiments of this approach.

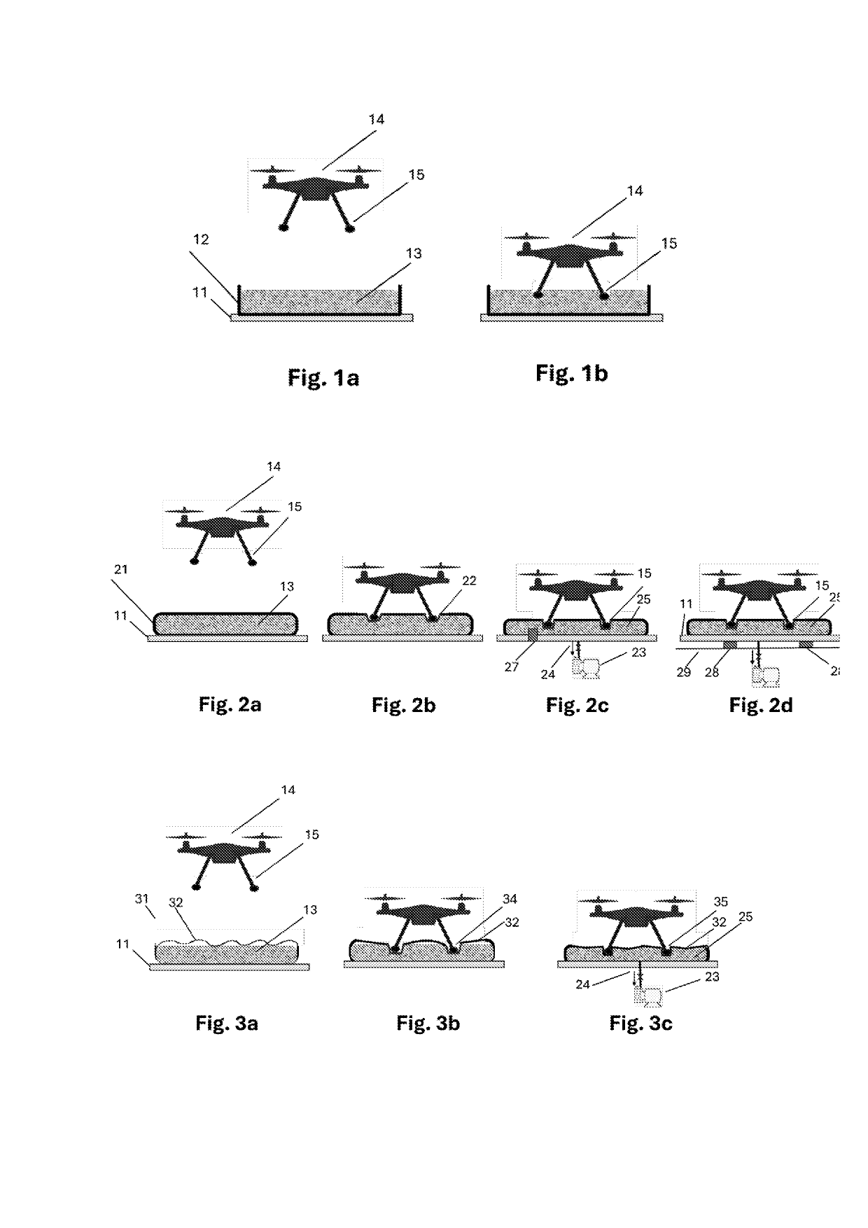

FIGS. 1A-1B show an embodiment of a landing pad where granules 13 are allocated into box 12 with an open surface, also referred to herein as an open-air receptacle. Box 12 is optionally arranged on a pad base 11. Drone 14 is provided above the pad (in the view of FIG. 1A) and after touchdown on the granules (in the view of FIG. 1B). The force of gravity causes legs 15 to penetrate the layer of granules 13. In this embodiment the box bottom may be rigid, and thus also may serve as a pad base 11.

Pad base 11 may be produced of metal, plastic, wood, hard plastic, or any other hard material. The ship deck, automobile roof, or a building roof may also serve as a base.

Box 12 may be made of metal, wood, plastic, rubber, etc. Optionally, box 12 includes small holes at the bottom thereof, underneath the layer of granules 13, to permit drainage of sea water or rainwater from the box 12.

Because granules 13 are directly exposed to legs 15, and are not enclosed in a receptacle, legs 15 may descend relatively deeply into granules 13. The granules 13 thus considerably decrease the aerial vehicle’s likelihood of bouncing, or from sliding laterally or from tipping over.

The embodiment of FIGS. 1A-1B features various advantages over known landing pads. In particular, the landing pads decrease bouncing and slipping of the landing gear. This is even the case when the pad is moved up and down and side to side due to waves and movement of the vehicle or boat.

FIGS. 2A-2D show an embodiment whereby granules 13 are enclosed into a sealed container. The container 21 is made of a pillow-like material, and is also referred to herein as a “pillow.” The container 21 is thin, flexible, waterproof and airtight. In FIG. 2A, drone 14 is shown above the pad. After the drone lands on the pillow, its legs 15 (FIG. 2B) are embedded into the pillow filled with granules 22. Such an embodiment is a preferred alternative relative to the open box of FIGS. 1A-1B, protecting the granules from water and contamination from dirty legs. The pillow 21 may further includes a vacuum source 23 connected to the pillow, with or without a valve 24 (FIG. 2C). The pad may have a sensor 27, shown in FIG. 2C, which senses that the drone legs are in contact with the pillow and activates a vacuum source automatically. The sensor may be an accelerometer or proximity sensor. A preferred manner to sense the landing is illustrated in FIG. 2D, which illustrates a single or plurality of load cells 28 installed between the pad base 11 and a support 29. The load cells 28 have one or more strain gauges. Advantageously, in such embodiments, the vacuum engages to lock the landing gear in an automated process as soon as the landing gear touches down on the landing pad, thereby protecting the aerial vehicle and preventing it from tipping over or slipping off the landing pad.

Another way to activate the vacuum right after landing is based on trigger of changing a UAV state from “Armed” to “Disarmed.” This is a standard output indicating that the UAV has landed and stopped its motors. The UAV state may be communicated to the landing pad via a wireless communication link, as will be discussed further herein.

Following sucking out of air by applying a vacuum source 23 (FIG. 2C-2D) a shrinkage of the pillow occurs, as well as hardening of the volume 25 of the granules 13, while the granules 13 are compacted and packed closely around the leg 15, in a way that they are stuck together as a hard pack, leading to catching and locking the drone legs 15 to the pad. For AV takeoff, the vacuum valve is opened, and the in-pillow pressure rises, and the granules become dispersed, free to move, and are rendered soft, in a way that the AV legs are free to exit.

FIGS. 3A – 3C show a pillow-like container 31 that contains the granules and a volume of air above the granules. In this embodiment, there is an excess of soft, flexible pillow-like material. In this case, legs 15 penetrate deeper into the pillow 34 due to pillow material excess 32, thereby enabling better locking of the legs 15 (FIG. 3b). The excess of pillow-like material and excess of air above the granules provides a benefit of decreasing vehicle bouncing. In addition, this excess reduces the displacement of granules by the landing gear, thereby enabling better enfolding of the legs into the pillow 34, thereby leading to a stronger locking following the application of the vacuum. As seen in FIG. 3C, applying vacuum through pump 23 and valve 24 further secures the legs 15 to a locked state 35. The legs remain locked as long as the vacuum pump is operated or after the valve 24 is closed to keep the low pressure.

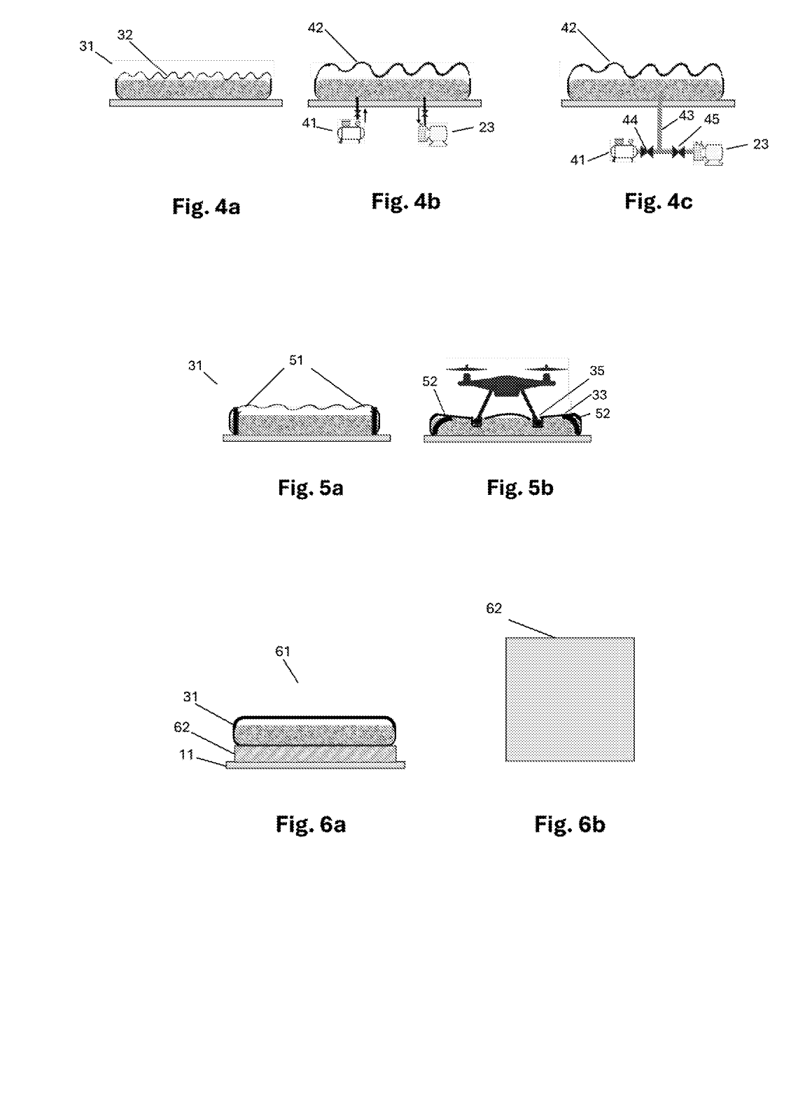

FIGS. 4a – 4c show spreading of excess of pillow material 32 above the surface, to improve locking of the drone legs 15. In this embodiment, air blowing into the pillow by air pump 41 (also referred to herein as a “blower”) is used for achieving the spreading 42. When an AV is approaching landing, the blower is activated by a command from the main controller. The blower stops once the pressure reaches a predefined value or after a defined period of time or after a volume of air is inflated. To stop, the inlet valve closes and then the blower stops. Air pump 41 may be connected to the pillow separately of the vacuum source 23 connection, as is shown in FIG. 4b. Another way is shown in FIG. 4c, where both air pump 41 and vacuum sources 23 are connected to the pillow by the common connection 43. Valves 44 and 45 may be used to control each source. The air pump, vacuum sources, and valves 44, 45 may be controlled by a manual or automatic controller, which switches on and opens the valves corresponding to process needs. After sensing that the drone touchdown process is completed, valve 45 is opened and vacuum source 23 sucks the air from the pillow and provides the required vacuum. Before the drone takes off, valve 45 is closed and valve 44 is opened, to provide the required portion of air into the pillow and thereby enable fast release of the legs of the aerial vehicle.

Based on experimental results, for effective expansion of the pillow material, the pillow volume should be 1.5-6 times greater than the volume of the layer of the granules. The volume of air that is pumped above the granules is preferably in the range of 5-50% of the pillow volume. Here, the “pillow volume” is calculated as the geometrical dimensions of the empty pillow. Experimental results indicated that the presence of described amount of air above the granules during a landing process has a significant effect on the quality of the locking that is achieved by the vacuum.

Another embodiment is related to a pillow which uses only air pump 41 and does not have vacuum source 23. A certain amount of air above the granules imparts smooth landing (no bouncing) and enables immersion of the legs into the granules layer, leading to certain drone stability on landing pad, even though is not so tough as with using vacuum 23.

Another way to spread the excess of pillow material is using flexible rubber columns or walls 51 (FIGS. 5A-5B). In a relaxed state, the columns elevate the upper surface of the pillow-like receptacle. With suitable column or walls design and materials, the columns or walls are bent during drone landing (shown in FIG. 5B as element 52) and return to their initial state 51 after the drone takes off.

In order to spread out the granules, base 11 (shown in FIGS. 1-2) could be shaken (small motion in one or all directions), immediately prior to the initiation of the landing process.

FIGS. 6A and 6B show a pad 61 with an addition of a foam rubber layer 62 located between base layer 11 and pillow 31. FIG. 6B illustrates a top view of foam rubber layer 62. The foam rubber layer 62 provides improved cushioning and improved leg locking. Specifically, the foam rubber layer may reduce the displacement of granules caused by the landing of the skids on the pillow 31. This causes a stronger locking around the landing gear after application vacuum, and further lessens the risk of the drone overturning during oscillation of the landing pad on waves. The thickness and degree of softness of the foam rubber may have an effect on the landing process. The density of the foam may be between 20 and 100 kg/m³ and the thickness may be between 10 and 100 mm. Polyurethane open pore foam is one suitable foam type. Memory foam is especially suitable for avoiding bouncing of the drone from the landing pad.

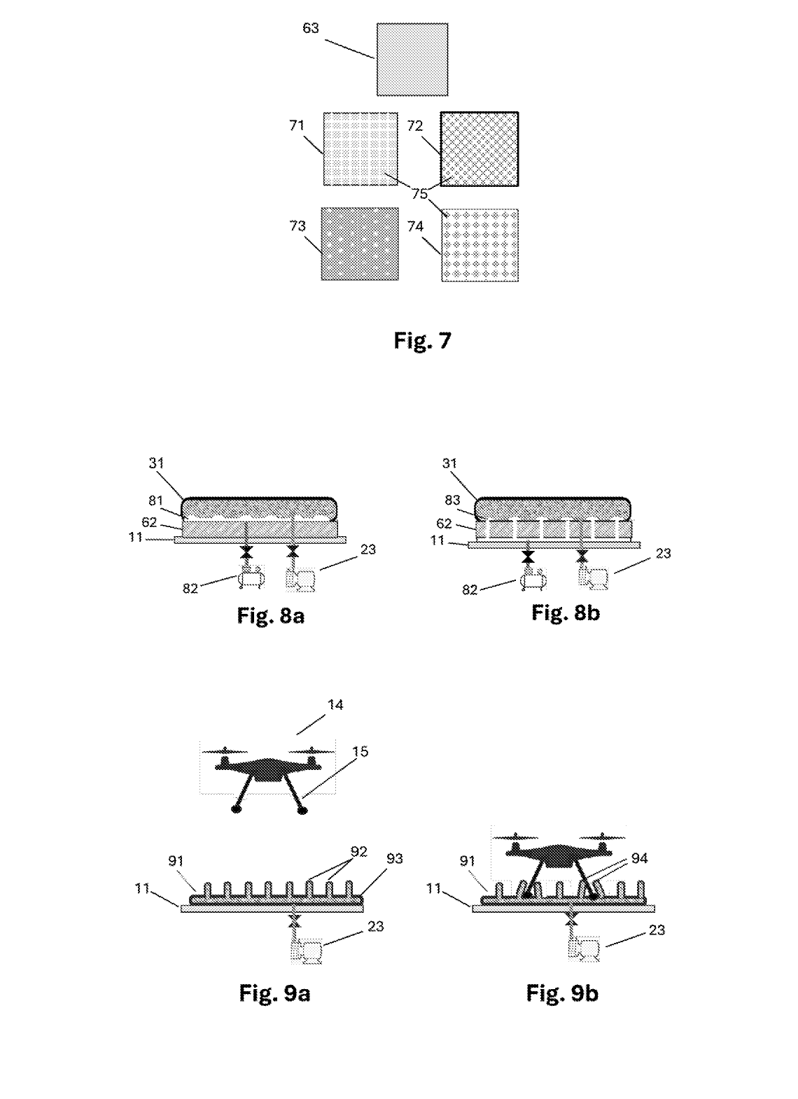

One of the ways to achieve various softness effects is by shaping the foam rubber. FIG. 7 shows examples of patterns 71-74. Patterns can be created by mechanical treatment of original bulky foam plate 62 or by adhering of foam elements 75 to base 11. Another example of patterned foam is acoustic foam with pyramidal or “egg crate” topography. Dimensions of pattern element 75 in length and width depend on design and may vary from 10 to 500 mm.

FIGS. 8a-8b show schematically another embodiment of a pad structure. Rubber or latex air bags 81 (FIG. 8A) or air pillars 83 (FIG. 8B) are positioned under the pillow 31 and connected to air source 82. A connection manifold can be allocated onto the foam layer 62 (element 81, FIG. 8a) or under the foam rubber layer 62 (element 83, FIG. 8b). The air also may be applied without using foam rubber layer 62 (not shown). After the drone landing, air source 82 inflates air into the air bags 81 and 83. Distending of the airbags moves the granules upwards within pillow 31, to direct the granules to cover the drone legs (not shown). Further applying of vacuum 23 leads to hardening of the pillow with granules 31 and strong, secure locking of the legs. In an alternative embodiment, the bag 81 may be sealed and filled with liquid such as water or gel, creating an identical effect. Specifically, application of pressure at one or more points (e.g., by landing of the aerial vehicle) causes the liquid below the unpressed surface to elevate, thereby elevating the granules or other particulate material within the pillow-like receptacle 21.

FIG. 9a-9b schematically show a pillow with granules in form of a matrix of pillars 91. Pillars 92 are placed at a distance equal or larger than the thickness of legs 15 and define interstitial areas therebetween. Then drone 14 lands and its legs 15 press on an interstitial area of pillow base 93 between the pillars. Corresponding pillars are bent over the legs 15 and enfold them, as shown at element 94. Subsequently, activation of vacuum source 23 leads to hardening of the pillars 92 and securing the drone.

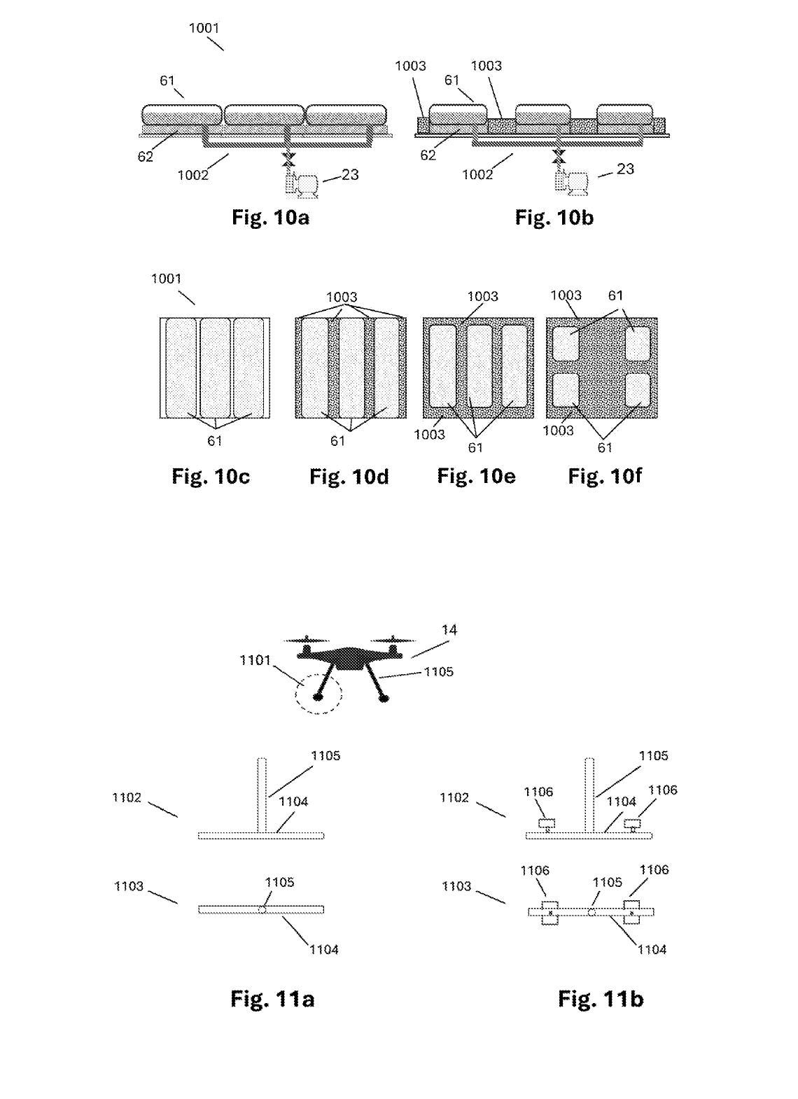

FIGS. 10A – 10F show a landing pad assembly 1001. Pad assembly 1001 differs from the previously described embodiments in that it is composed of multiple individual landing pads arranged on a common landing pad base. Each of the landing pads is made of a flexible, sealed, pillow-like container 61 with the granules inside. In the illustrated embodiment, the individual pillow-like landing pads are connected to one vacuum source by manifold 1002. Alternatively, each one may be connected to its own vacuum source.

In the embodiment of FIGS. 10A and 10C, the individual pillows are laid substantially next to each other, with no other material in between. This embodiment may be used, for example, when it is desired to enlarge the surface area used for the landing pad, in order to enable landing of larger aerial vehicles.

In the embodiments of FIGS. 10B and 10D-10F, the individual pillows are separated by one or more separators 1003. The separators and individual pillows may be lined up in strips, similar to a crosswalk, or in any other suitable configuration. The size of the individual landing pads in the assembly, the orientation and distances between the individual pads, pillow size, distances between the pillows and the location of the pillows may be set to ensure that at least a part of the skid will land on the pillow. This configuration, on the one hand, saves on cost and weight and improves efficiency, since, generally, the aerial vehicle may be guided to land on a specific portion of the landing pad assembly. It also enables a decrease in vacuum build time (since comparatively less volume needs to be evacuated) leading to faster locking of the aerial vehicle. Furthermore, there is no need for granules and a locking mechanism in the space that is between the landing skids. On the other hand, the interstitial material may also serve to dampen an impact of the landing gear, in the event that the landing gear does land between the landing pads. In particularly advantageous embodiments, to avoid drone instability in case the part of the skid lands on the channels between the pillows, the separators are made of foam rubber 1003, as shown in FIG. 10B and FIGS. 10D-10F. The height and pattern of the foam rubber is adjusted to supply similar pad reaction (flexibility, bouncing, skid incline) that occurs with the pillows. The most suitable foam for this approach is a memory foam, known also as viscoelastic or Visco foam. The density of the memory foam may between 20 and 100 kg/m³ and the thickness may be between 10 and 100 mm.

In FIGS. 10A and 10C the small pillows with the granules are stitched to each other. In FIGS. 10B and 10D-10F the small pillows are separated by a foam rubber. In FIGS. 10E-10F the small pillows have an exterior frame made of foam rubber.

In an alternative embodiment to those presented above, instead of the landing pad being made principally with granules as discussed, the landing pad may be made entirely of memory foam. The memory foam may be enclosed in waterproof fabric for mechanical and environmental protection. The foam pad can be enclosed in an airtight fabric or pillow-like material. The pillow may have an excess of pillow material and be partially filled with air. The air imparts touchdown smoothness and reduces the bounce back. This solution may be applied in case of relatively quiet weather conditions.

Pillows 21, 31, 61 as described above may be prepared of flexible materials like plastic or rubber film, fabrics, or combinations of those materials, by adhering two or more layers of same materials or different materials by hot or cold lamination or coatings. The thickness of pillow materials is in the range of 0.03 to 2 mm, preferably 0.1-0.5 mm.

The pillow material is resistant to the marine environment and is impermeable to air.

Regarding materials of the granules (including in the embodiment of FIGS. 1A-1B), the granules may be granules, grains, particles of diameter 0.1-10 mm, preferably 0.5-5mm. A non-exhaustive list of examples of granules includes metal, plastic, or ceramic beads, plastic pellets, or even natural grains such as couscous, buckwheat, bulgur quinoa grains, or coarse sand. The grains may be soft or hard. The thickness of the granules layer in the pillow may be between 5-300 mm, and preferably 10-50 mm. In one advantageous embodiment, the granules are made of plastic pellets having a size of between 1 and 5 mm. Such plastic pellets are durable, environmentally stable and are readily commercially available. Some pellet types like polyethylene or polypropylene have a low friction coefficient, allowing good flow of the granules and enfolding by the penetration of the legs.

In some embodiments, instead of filling with granules, the box (FIGS. 1A-1B) or pillow-like container (FIGS. 2A-10F) may be filled with pieces or layers of materials like foam, fabrics, felt, rubber, leather, fluff and others. As used in the present disclosure, the term “granules or other particulate material” encompasses materials such as those listed above, or any other suitable material that may be rearranged in shape through application of a vacuum and/or mechanical motion.

In some embodiments, instead of filling with granules, the granules may be replaced with particles that can respond to electrical or magnetic fields, including a magnetic fluid, and magnetic fields may be applied instead of or in addition to vacuum.

Foam rubber layer 62, when present, may have a thickness of 5-100 mm, preferably 20-60 mm. Suitable foam types may include polyurethane (PU), silicone, ethylene propylene diene monomer (EPDM) rubber, or open or closed pores. Felt and soft rubber also can be used as a foam layer. Preferably, the foams have a density below 100 kg/cubic m.

As discussed above, in some conditions (large ships, moderate waves and winds) the landing pad may be prepared from the foam layer without a pillow and granules. In this case, the foam is covered with a flexible material that is resistant to marine environment.

The pillow, the foam or both may be installed in a box with an open top, like box 12 in FIGS. 1A-1B. Box covers may be installed for covering when the landing apparatus is not in use.

The vacuum level for pillow hardening is 10-800 mbar (7-600 mm Hg), preferably 80-500 mbar (60-370 mm Hg). Suitable vacuum sources 23 are a vacuum pump or a vacuum tank, air deflator, or even the vacuum pump from a strong dust cleaner.

The air supply sources 41, 82 may be, without limitation, compressors, blowers, inflators and pressurized tanks with inert gas. The advantage of the pressurized tank is the elimination of contamination from the system with marine salt and moisture.

Another solution combining air vacuuming and air blowing and avoiding marine environment problems is a piston with a tank system. In such closed cycle systems, any gas, not necessarily air, may be used during inflation or deflation of the container. The tank is configured for storage of air or other gas withdrawn from the container or pillow during application of the vacuum for hardening the granules layer and for resupply the air or other gas to the container during release of the vacuum for releasing the drone legs. A closed system does not use any external air.

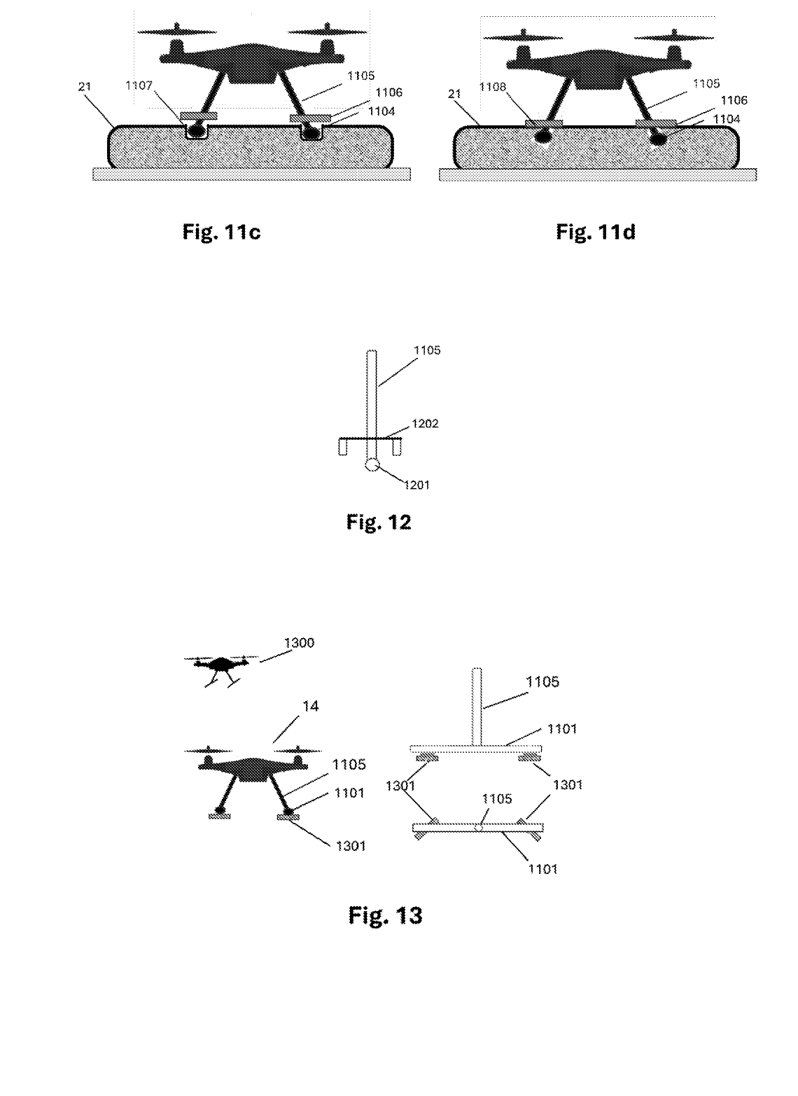

A system for landing a vertically landing aerial vehicle may include the landing pad as described in the above embodiments and a special configuration of the legs of the aerial vehicle. The size and design of legs 15 influences the quality of landing and securing. See FIG. 11a with an example of a drone with a standard leg configuration. Drone 14 comprises legs 1105. Circle 1101 delineates the lower part of leg 1105. View 1102 represents schematically a side view of lower part 1101, and view 1103 represents a top view of lower part 1105. Skid 1104 is a lower leg component which, upon landing, is embedded into the pad. FIG. 11b shows an embodiment with an additional upper leg securing component 1106. At the first stage of landing (shown in FIG. 11c) the lower leg component 1104 penetrates the pillow and creates channel 1107. As the drone continues to descend, upper leg securing component 1106 touches and presses the pillow surface, causing partial closing of the channel in the top and enhancing the surrounding of the lower part of the leg 1108 (FIG. 11d). These legs could be connected to any existing legs as an add on or as part of the entire leg.

FIG. 12 shows another example of leg design with lower 1201 and upper 1202 components of the legs. In this embodiment, upper leg components 1202 are relatively narrower and vertically longer, compared to components 1106 of the previous embodiment.

FIG. 13 shows further example of leg design for drone 1300, based on standard leg configuration 1101 and 1105 in a skid configuration, with the addition of small skids 1301. The small skids 1301 may be provided at an angle relative to the landing gear. The length, diameter and angle of skids 1301 may be optimized to get good penetration and catching performance.

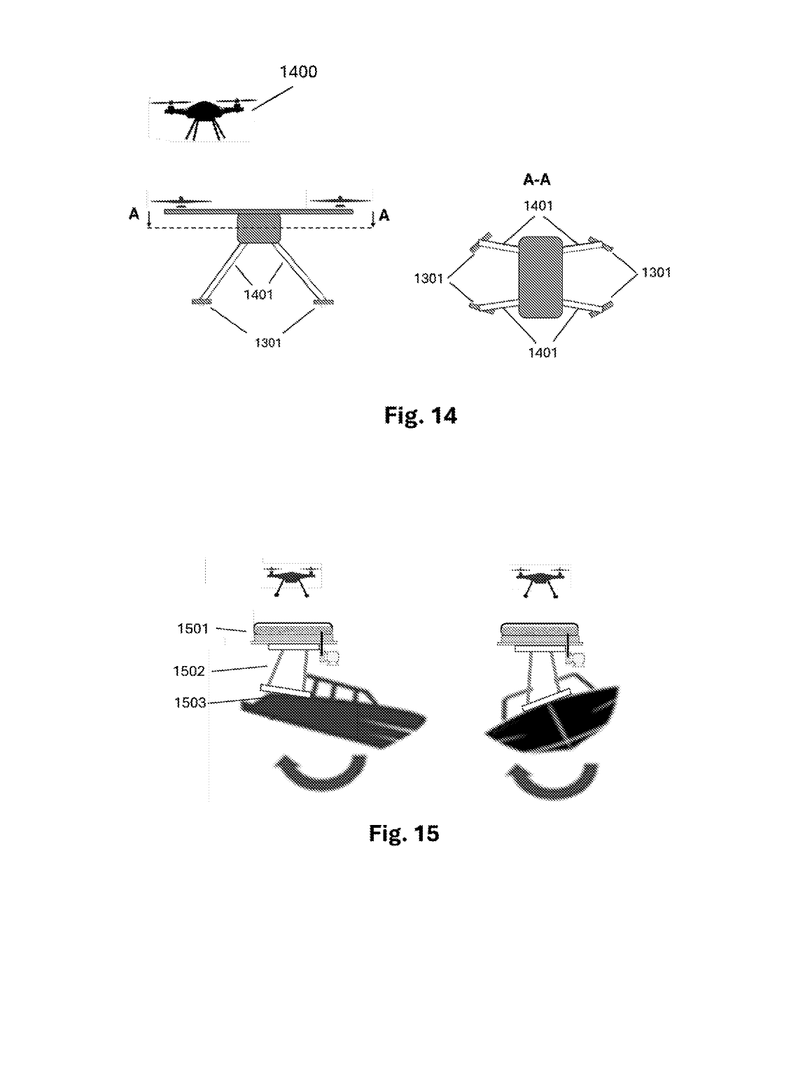

The same approach can be applied to drone 1400 (FIG. 14) with separate legs 1401. In this embodiment, instead of the drone having two skids on either side, the drone has four separate legs 1401. Each of the legs has a small skid 1301, in the manner discussed above.

In some embodiments, the edges of the skids that are in contact with the pillow may be of different shapes, different sizes, different materials, or different surface roughness / smoothness. The skids may have rough or engraved surfaces. In other embodiments, the skids can be coated with material with high friction coefficient, for example rubber coated.

The diameter of a horizontal element of skid may have profile as thin as 5 mm to 50 mm.

Referring to FIG. 15, the landing pad 1501 may be installed on a gyroscopically stabilized electro-mechanical structure 1502. This structure may be controllable to orient the landing and enables the landing pad to be constantly horizontal no matter what the condition of the waves and the ship (or other vehicle). The stabilizing mechanism may be used to stabilize the landing pad in all horizontal directions and in all angles.

The structure 1502 may include: a base that is fixed to the movable vehicle; the landing pad, in one of the embodiments discussed above; a plurality of extendable and retractable legs configured between the base and the landing pad; at least one inertial measurement unit configured to measure speed, acceleration, and a controller configured to: receive measurements from the at least one inertial measurement unit; receive data regarding speed, acceleration, and angular orientation of the aerial vehicle; and control extension and retraction of each of the legs.

In some implementations, the controller is configured to maintain the touchdown surface (the upper surface of the landing pad) substantially horizontal relative to ground or sea level. In addition or in the alternative, the controller may be configured to maintain the touchdown surface parallel to a plane of descent of the aerial vehicle, even when said plane of descent is not horizontal relative to the ground or sea level.

The structure 1502 may include at least one sensor configured to detect movements of the aerial vehicle relative to the landing pad. In such embodiments, the controller may be configured to determine the speed, acceleration, and angular orientation of the aerial vehicle by analyzing data gathered by the at least one sensor. Optionally, the at least one sensor comprises one or more of an electrooptic sensor, an infrared sensor, a magnetic sensor, an electro-magnetic sensor, radio, radar, LIDAR, or LADAR. The structure 1502 further includes one or more inertial measurement units (IMS) configured to measure speed, angular velocity (ω), acceleration, and angular orientation. The inertial measurement units 20 may include, for example, gyroscopes and acceleration sensors.

The structure 1502 may include, for example, between two and six legs. The legs may be configured to adjust the touchdown surface in one to three angular directions and one to three translational directions. The controller may be configured to control extension and retraction of the legs so as to prevent lateral movement of the touchdown surface within a plane. The structure 1502 may alternatively include any other means for adjusting the orientation of the touchdown surface in six degrees of freedom.

The structure 1502 may further include a communication unit for communicating between the structure 1502 and the aerial vehicle. In such embodiments, the controller may be configured to receive the data regarding speed, acceleration, and angular orientation of the aerial vehicle via a communication link between the communication unit and the aerial vehicle. Optionally, the controller is configured to determine flight commands to deliver to the aerial vehicle for guiding a landing of the aerial vehicle.

The landing pad may further include a visual marker for photographic detection of the touchdown surface by an image sensor of the aerial vehicle.

FIG. 16 illustrates a process of the aerial vehicle’s legs meeting the landing pad when the landing pad structure 1502 is on a rocking ship 1503. The landing pad’s controller and sensors, represented as element 1601, calculate and predict the future location 1602 of the landing pad, based on the trajectory 1605 of the ship 1503. The controller then sends instructions 1603 to the aerial vehicle, guiding the aerial vehicle to a flight path 1604, to the future location 1602. Throughout this process, the landing pad is maintained horizontal relative to the horizon, even though the ship 1502 is rocking underneath it. The orientation of the aerial vehicle 14 is illustrated in this Figure as being substantially parallel to that of the landing pad, although it need not be.

Experimental results have indicated that, when the landing pad of the present disclosure is employed as the touchdown surface, the landing pad secures the aerial vehicle even when the aerial vehicle is not angularly aligned with the landing surface. The granules that are contained within the landing pad are sufficiently displaceable so as to enable the skids or landing gear to be embedded therein, even when the skids initially enter on an angle. Advantageously, the degree of calculation and control that is required for orienting the landing pad is comparatively simple, as all that is necessary is to maintain the landing pad at a constant horizontal angle relative to the horizon, and without further requiring adjusting the pitch or roll angles of the landing pad relative to that of the incoming aerial vehicle.

A method of landing a vertically landing aerial vehicle using the landing pads described above may include, generally: lowering legs of the aerial vehicle on a landing pad comprising a plurality of granules or other particulate material arranged in a container, said container arranged on top of a pad base, and a vacuum pump configured to withdraw air from the container; embedding the legs of the aerial vehicle within the granules or other particulate material; and applying a vacuum to the container to thereby compact the granules or other particulate material and lock the granules or other particulate material at least partially around the legs. The lowering step may include lowering the aerial vehicle to a distance of 10-1000 mm, or preferably 100 – 500 mm, from the surface of the pad using a motor of the aerial vehicle, and lowering the aerial vehicle a remaining distance to the landing pad using gravity. The amount of vacuum to be applied may be determined based on the force required in order to embed the legs of the UAV into the granules, based on the mass of the UAV and the shape of the legs of the UAV. Optionally, air may be pumped into the landing pad prior to touchdown of the aerial vehicle on the pad.

Various modifications may be implemented to the embodiments described above. For example, in the above-described embodiments, a single landing pad is designed to support the entire aerial vehicle. This configuration is appropriate for relatively small sized aerial vehicles. In other embodiments, in which the aerial vehicle is very large, such that the distance between the legs or landing skids is (for example) three meters or greater, a landing system may include multiple separate landing pads as described herein. Each landing pad may be installed on a structure as described in FIG. 15 and may be independently controllable in spatial orientation. For aerial vehicles with four separate legs (as in FIG. 14), there could be four separate landing pads and structures.

EXAMPLE: Preparation of landing pad as shown in FIGS. 6A-6B.

Pillow 650x650 mm is prepared of PU (polyurethane) coated nylon fabrics of 80 g/m² by gluing corresponding pieces around the borders with spray adhesive, leaving a small un-sealed space for filling the granules and the connection to a vacuum line.

The pillow is filled with 10 kg of granules or particulate matter. A reversible vacuum pump is connected and sealed to the pillow.

Open pore polyurethane foam with a density 25kg/m³ and dimensions of 600x600x4mm is placed on the bottom of a wood box of 600x600x100mm.

The pillow is placed above the foam. The pillow has an excess of soft, flexible fabric material which is collected in the top area of the pillow.

A 3 kg weight drone frame (500mm quadcopter) was dropped on the pad from a height of 400mm. No jump/bouncing back occurred, and the drone legs penetrated into the pad for about 25mm. After applying a 300 mbar vacuum, the legs were strongly secured in the pad.

1. A landing pad for a vertically landing aerial vehicle, comprising:
a planar pad base;
a flexible, sealed container arranged on the planar pad base,
wherein the container is made of a soft, flexible material and thereby constitutes a pillow-like receptacle,
wherein the container includes granules that are dispersed, thereby permitting embedding of legs of the aerial vehicle within the granules and withdrawal of the legs from within the granules, and
wherein the pillow-like receptacle comprises excess soft, flexible material configured above the granules,
wherein, upon landing of the legs of the aerial vehicle onto the landing pad, the legs depress a portion of the excess soft, flexible material prior to becoming embedded between the granules.

2. The landing pad of claim 1, wherein the granules are comprised of one or more of metal beads, plastic beads, ceramic beads, plastic pellets, coarse sand, couscous, buckwheat, bulgur, or quinoa grains, or powders.

3. The landing pad of claim 1, further comprising a foam rubber layer configured between the container and the pad base, wherein the foam rubber layer has a density of less than 100 kg / cubic meter.

4. The landing pad of claim 3, wherein the foam rubber is a memory foam.

5. The landing pad of claim 4, wherein the foam rubber has a patterned surface in a pyramidal or egg crate topography.

6. The landing pad of claim 1, wherein the container is sealed, and further comprising
a vacuum source configured to withdraw air from the container;
wherein, in the absence of a vacuum, the granules are dispersed, thereby permitting embedding of legs of the aerial vehicle within the granules and withdrawal of the legs from within the granules, and, in the presence of a vacuum, the granules are compacted, thereby locking the legs when the legs are embedded within the granules, and, when the vacuum is released, the legs are released from being locked.

7. The landing pad of claim 6, further comprising:
a sensor for determining when legs of the aerial vehicle are embedded within the granules, and
a controller configured to activate the vacuum source upon determination that the legs are exerting pressure on the granules.

8. The landing pad of claim 7, wherein the sensor is a load cell.

9. The landing pad of claim 7, wherein the controller is configured to activate vacuum right after landing upon wireless receipt of a change in a state of the trigger of changing UAV state from “Armed” to “Disarmed”.

10. The landing pad of claim 6, further comprising an air pump configured to supply air in the pillow-like receptacle prior to landing of the aerial vehicle on the landing pad, or prior to release of the aerial vehicle from the landing pad.

11. The landing pad of claim 1, further comprising flexible rubber columns within the pillow-like receptacle that, in a relaxed state, elevate the upper surface of the pillow-like receptacle and are bent upon landing of the aerial vehicle on the surface of the pillow-like receptacle.

12. The landing pad of claim 1, further comprising one or more air bags with a plurality of hollow pillars arranged underneath the pillow-like receptacle, and a pump configured to pump air into the one or more air bags to inflate the pillars and thereby elevate the granules within the pillow-like receptacle.

13. A landing pad assembly comprising a plurality of the landing pads of claim 1 arranged on a common landing pad base.

14. The landing pad assembly of claim 13, further comprising a plurality of separators arranged between the landing pads, wherein the separators are made of memory foam.

15. A system for landing a vertically landing aerial vehicle comprising the landing pad of claim 1, wherein an upper surface of the landing pad functions as a touchdown surface, wherein the landing pad is arranged on a vehicle,
at least one inertial measurement unit configured to measure speed, acceleration, and angular orientation of the base in six dimensions;
a sensor located on the landing pad for tracking the aerial vehicle and for providing a position of the aerial vehicle relative to the landing pad;
and a controller configured to:
receive measurements from the at least one inertial measurement unit;
receive data regarding speed, acceleration, and angular orientation of the aerial vehicle from the sensor;
calculate and predict a future location and orientation of the landing pad based on expected future movement of the vehicle; and
provide flight instructions to the aerial vehicle so that the aerial vehicle will land on the landing pad with minimal relative position and velocity errors.

16. The system of claim 15, further comprising an electromechanical structure configured to stabilize the touchdown surface during movement of the vehicle, wherein the controller is configured to control the electromechanical structure so as to maintain the touchdown surface substantially horizontal relative to ground or sea level while the aerial vehicle is landing.

17. The system of claim 16, wherein the electromechanical structure comprises a plurality of extendable and retractable legs enabling lateral movement of the touchdown surface.

18. A landing system comprising a plurality of the landing pads of claim 1, wherein, for each of the landing pads:
an upper surface of the landing pad functions as a touchdown surface, the landing pad is arranged on a vehicle, at least one inertial measurement unit is configured to measure speed, acceleration, and angular orientation of the base in six dimensions;
a sensor is located on the landing pad for tracking the aerial vehicle and for providing a position of the aerial vehicle relative to the landing pad, and a controller is configured to:
receive measurements from the at least one inertial measurement unit;
receive data regarding speed, acceleration, and angular orientation of the aerial vehicle from the sensor;
calculate and predict a future location and orientation of the landing pad based on expected future movement of the vehicle; and
provide flight instructions to the aerial vehicle so that the aerial vehicle will land on the landing pad with minimal relative position and velocity errors;
wherein each landing pad is installed on a separate electromechanical structure configured to stabilize the touchdown surface during movement of the vehicle, and each controller is configured to control the electromechanical structure so as to maintain the touchdown surface substantially horizontal relative to ground or sea level while the aerial vehicle is landing, and each electromechanical structure is independently controllable in spatial orientation.

19. A method of landing a vertically landing aerial vehicle, comprising:
lowering legs of the aerial vehicle on a landing pad comprising a plurality of granules arranged in a flexible sealed container, wherein the landing pad further comprises a vacuum pump configured to withdraw air from the container;
embedding the legs of the aerial vehicle within the granules; and
applying a vacuum to the container to thereby compact the granules and lock the granules around the legs.

20. The method of claim 19, wherein the container is a sealed flexible container with the granules inside, wherein the landing pad further comprises an air pump, and wherein the method further comprises, prior to the lowering step, pumping air into the container.

21. The method of claim 19, further comprising, prior to the step of pumping air into the container, withdrawing air from the container until the container reaches a default minimum internal pressure, and wherein the step of pumping air into the container comprises raising an internal pressure in the container to a predetermined level.

22. The method of claim 19, further comprising, during performance of the other steps, stabilizing the landing pad with an electromechanical structure equipped with sensors to measure motion of a vehicle on which the landing pad is arranged so as to prevent lateral movement of the touchdown surface within a plane.
